(19) United States
(12) Patent Application Publication
(10) Pub. No.: US 2014/0095658 A1
(43) Pub. Date: Apr. 3, 2014

(54) Information Aggregation on a Mobile Offshore Drilling Unit

(71) Applicant: TRANSOCEAN SEDCO FOREX VENTURES LIMITED, Houston, TX (US)

(72) Inventors: Trenton Martin, Kingwood, TX (US); Donn Nguyen, Missouri City, TX (US)

(73) Assignee: Transocean Sedco Forex Ventures Limited, Houston, TX (US)

(21) Appl. No.: 13/843,568

(22) Filed: Mar. 15, 2013

Related U.S. Application Data
(60) Provisional application No. 61/708,970, filed on Oct. 2, 2012.

(51) Int. Cl. G06F 15/173

(52) U.S. Cl. CPC G06F 15/17306
USPC 709/217

(57) ABSTRACT

Information on a mobile offshore drilling unit may be aggregated and transferred to an off-shore location. Data may be retrieved in real time from a plurality of control systems on an offshore drilling vessel, wherein each of the plurality of control systems controls a different component of the vessel. The data may be aggregated at a single location on the vessel. The data may be converted into a standard format and transmitted to one or more shore-based locations, where centralized support, management, and monitoring may be provided from the one or more shore-based locations.

### CROSS-REFERENCE TO RELATED APPLICATIONS

This application claims priority to U.S. Provisional Application No. 61/708,970 to Trenton Martin et al. entitled “Information Aggregation on a Mobile Offshore Drilling Unit” and filed on Oct. 2, 2012, which is hereby incorporated by reference in its entirety.

### TECHNICAL FIELD

This application is directed to information processing and more specifically to a method and system for aggregating information on a mobile offshore drilling unit.

### BACKGROUND

In an offshore drilling unit, such as a vessel, different features of the drilling vessel may be controlled by different control systems. Because a drilling vessel may include equipment manufactured by different manufacturers, there may often be a lack of standardized control mechanisms across the control systems that control the different equipment. As a consequence, data retrieved from each of the control systems may be formatted differently, use different units, and be difficult to transmit using a standard format. The lack of standardization leads to isolation between the control systems, as well as difficulties in operating, monitoring, supporting, or managing the different control systems from a location remote to each of the control systems.

### BRIEF SUMMARY

According to one embodiment, a method includes retrieving real-time data from a plurality of control systems on an offshore drilling vessel, wherein each of the plurality of control systems controls a different feature of the vessel. The method also includes aggregating the data at a single location on the vessel. The method further includes converting the data into a standard format, and transmitting the converted data to one or more shore-based locations, whereby centralized support, management, and monitoring is provided from the one or more shore-based locations.

According to another embodiment, an apparatus includes at least one control system on an offshore drilling vessel, wherein each of the at least one control system controls a different feature of the vessel. The apparatus also includes a server in communication with each of the at least one control system. The server may be configured to retrieve real-time data from the at least one control system, and to aggregate the data. The server may also be configured to convert the data into a standard format, and to transmit the converted data to one or more shore-based locations, whereby centralized support, management, and monitoring is provided from the one or more shore-based locations.

According to yet another embodiment, a computer program product includes a non-tangible computer readable medium with code to retrieve real-time data from a plurality of control systems on an offshore drilling vessel, wherein each of the plurality of control systems controls a different feature of the vessel, and to aggregate the data. The medium also includes code to convert the data into a standard format, and to transmit the converted data to one or more shore-based locations, whereby centralized support, management, and monitoring is provided from the one or more shore-based locations.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a method for aggregating information on a mobile offshore drilling vessel according to one embodiment of the disclosure.

FIG. 2 is a block diagram illustrating components of a control system information aggregation according to one embodiment of the disclosure.

FIG. 3 is a graph illustrating an average bandwidth utilization while transmitting to shore for an aggregating server on a drilling vessel according to one embodiment of the disclosure.

FIG. 4 is a block diagram illustrating aggregation framework of a system for aggregating information on a mobile offshore drilling unit according to one embodiment of the disclosure.

FIG. 5 is a block diagram illustrating an example of an OLE for Process Control (OPC) DA and HDA synchronization architecture with tunneling and aliasing according to one embodiment of the disclosure.

FIG. 6 is a block diagram illustrating a computer system according to one embodiment of the disclosure.

### DETAILED DESCRIPTION

Connectivity to multiple control systems on a drilling vessel may be established to consolidate data and alarms, to provide remote support capabilities, and to manage control system software remotely. In one embodiment, the connectivity to the multiple control systems may be realized at a single location by aggregating disparate information from the control systems at the single location, and converting the format of the disparate data from each control system to a common standard format.

Through aggregation and standardizing of the data, an equivalent information aggregation architecture may be implemented at a plurality of mobile offshore drilling vessels to provide access and control to the control systems of the drilling vessels from one or more remote locations located on shore. By converting data from multiple control systems to a format common to multiple vessels, the data may be transmitted to the one or more remote locations, where standard tools may be used to process the data and provide support for any one of the multiple control systems on the plurality of drilling vessels. Advantageously, once the data is in a single location, centralized or regional support and monitoring may become more effective, and standardization of process and tools can be leveraged.

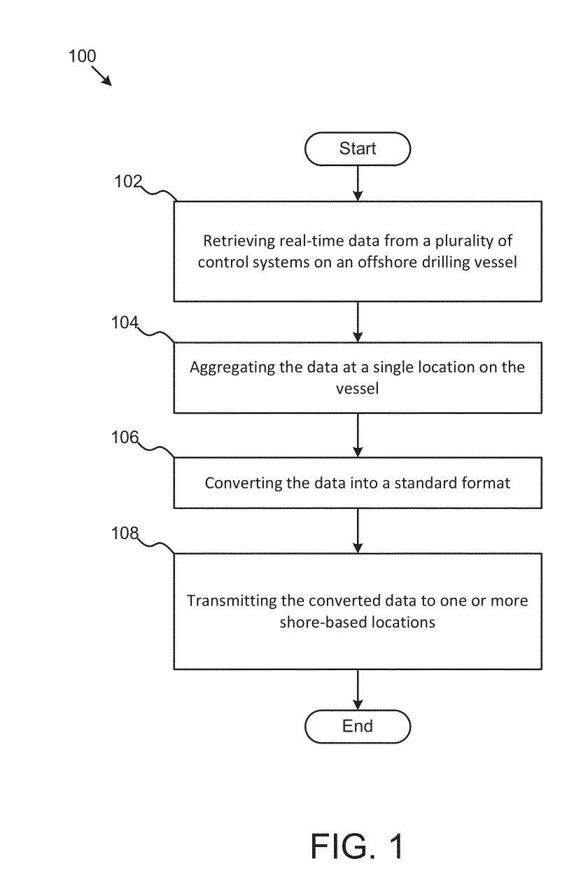

FIG. 1 is a flow chart illustrating a method for aggregating information on a mobile offshore drilling vessel according to one embodiment of the disclosure. A method 100 begins at block 102 with retrieving data, which may include real-time data, from a plurality of control systems on an offshore drilling vessel. According to one embodiment, each of the plurality of control systems may be located on the drilling vessel and may control a different component of the drilling vessel. For example, one control system may manage power on the vessel, while another control system may control drills. In some embodiments, the retrieved data may include data providing information about equipment on the drilling vessel, data providing alarm management information, or a combination of such information. In another embodiment, the drilling vessel may include a server in communication with each of the plurality of control systems, and the server may be configured to retrieve the real-time data from at least one control system.

The method 100 continues to block 104 with aggregating the data at a single location on the vessel. In one embodiment, the single location may be the server on the drilling vessel, and the server may be configured to aggregate the retrieved data. The data that is retrieved from the plurality of control systems may also be stored at the single location. For example, the server may be configured to store the data. In other embodiments, the data may be stored at remote locations, such as locations on shore or at locations other than the server.

The method 100 may continue to block 106 where the data may be converted into a standard format. In one embodiment, the server may be configured to convert the data into the standard format. With the data converted to a standard format, the method may proceed to block 108, with transmitting the converted data to one or more shore-based locations. The server located on the drilling vessel may be configured to transmit the converted data to one or more shore-based locations. By transmitting the converted data to one or more shore-based locations, centralized support, management, and monitoring may be provided from the one or more shore-based locations. Centralized support, management, and monitoring may control at least one of the plurality of control systems on the vessel via communication with the single location, such as the server. For example, a user at a one of the one or more shore-based locations may be in communication with the server on the drilling vessel, and by providing support or management or monitoring, the user at the shore-based location may send instructions to the server. The server may process the instructions and provide control instructions to at least one of the plurality of control systems on the vessel in accordance with the instructions the server received from the shore-based location.

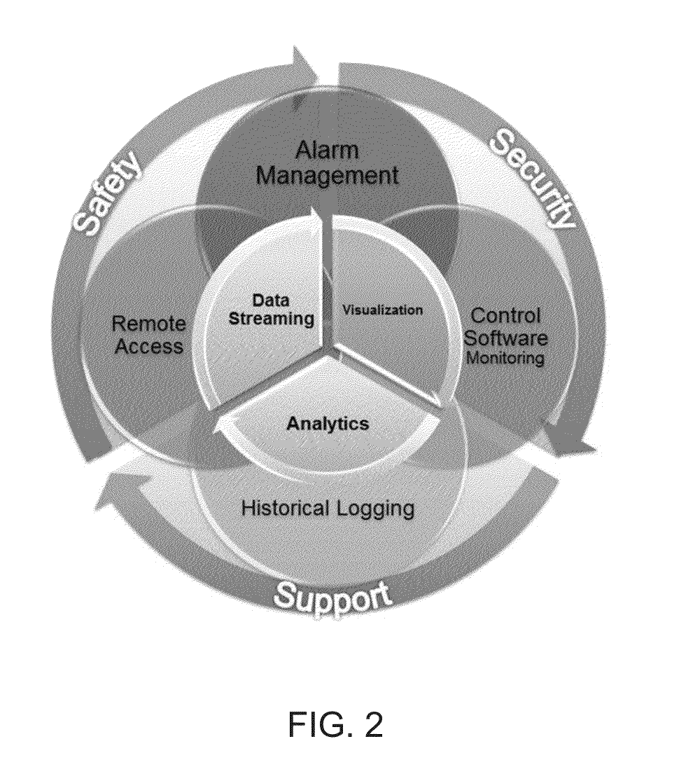

FIG. 2 is an illustration of some of the areas of attention and concern for control system information aggregation according to one embodiment of the disclosure. Regarding safety, an embodiment of this disclosure may allow operators to be virtually onboard the drilling vessel with the ability to troubleshoot and diagnose problems through secure, password protected, virus-free, remote access to a specific control system. Remote control may allow applicable safety policies to be adhered to as if the individual were physically onboard and interacting directly with that control system.

Regarding security, an embodiment of this disclosure may allow connectivity to multiple control networks in a manner that would require no changes to network devices, yet still be able to extract necessary information. In some embodiments, each control system may have a plurality of networks. Various embodiments of this disclosure provide for varying security features. For example, in one embodiment an information aggregation system may access any control system subnet even if they are using overlapping internet protocol (IP) address spaces, while in another embodiment clients and control systems may have restricted access to the data in an aggregation system. According to another embodiment, a control system subnet may be prohibited from accessing an aggregation system or any other control system subnet, including itself. In yet another embodiment, network configuration changes in the aggregation network and possibly the control system network as well may be monitored and/or reported.

In some embodiments, various security features are employed while maintaining a relatively standard, scalable, and low complexity network design by ensuring the physical and logical separation between three zones of activities. The three zones of activity may include a corporate zone, such as an intranet, a zone for an information aggregation system, and a third zone for the control systems on a vessel. The corporate zone and the information aggregation system zone may each have their own set of switches with a virtual local area network (VLAN). In one embodiment, each control system network may use a default VLAN preconfigured in a switch. Switches may allow devices in the same VLAN to freely communication with any member in the VLAN on layer 2 of the Open System Interconnection (OSI) model. However, in other embodiments, some switches may have a “protected port” feature that may prevent devices from communicating to each other at layer 2, even if they are on the same VLAN. For example, the “protected port” feature may force the devices to route traffic via layer 3 devices, such as a firewall or a router.

According to an embodiment, zones may be logically separated with a demarcation device, such as a router or a firewall. The term “firewall” may be used to describe the router or the firewall. Access restrictions may be implemented in either direction for any IP address and/or port combination to/from any of the zones using access rules. In some embodiments, the firewall may utilize virtualization to allow each third party subnet to be treated as a virtual router/firewall, which may solve the issue of overlapping IP addressing space.

Regarding support, various support models may be leveraged for different control systems. According to one embodiment, there may be at least three or four primary control systems on a vessel. When comparing Dynamically Positioned (DP) drill ships, semisubmersibles, jack-ups or moored vessels, there may be further variations in the systems. These variations can be due to differences in complexity or functional requirements. A high level categorization is provided in Table 1 below, describing for example a Vessel Management System (VMS), a Power Management System (PMS), a Multiplexed Control System (MUX), and a Blow-Out Preventer (BOP).

TABLE 1
Categorizing 4 drilling vessel control system types.

| | DP Rig | Moored Rig | Jackup |
|---|---|---|---|
| Vessel and Power | VMS/PMS | VMS/PMS | VMS/PMS |
| management | | | |
| Station Keeping | DP System | Mooring Control | Jacking System |
| Drilling Control/ | Drilling | Drilling | Drilling |
| Instrumentation | | | |
| Well Control | MUX BOP | BOP multiplex | Surface BOP |
| System | control | control system/BOP | control |
| | system | discrete hydraulic | system |
| | | control system | |

FIG. 2 illustrates how the method of FIG. 1 may be applied to a variety of applications. For example, historical logging applications, such as data logging and data aggregation, may bring together bits of information from drilling, DP/VMS, and subsea to a consolidated location. In another example, remote access may be provided. For example, an onshore expert may be provided remote access to the control systems on a vessel to provide support for the vessel. As another example, vendors at remote locations may access the vessels to monitor control software. Remote management of alarms in the control systems may be provided to prevent alarm issues, such as chattering alarms, incorrect categorization of alarms and events, and incorrect prioritization.

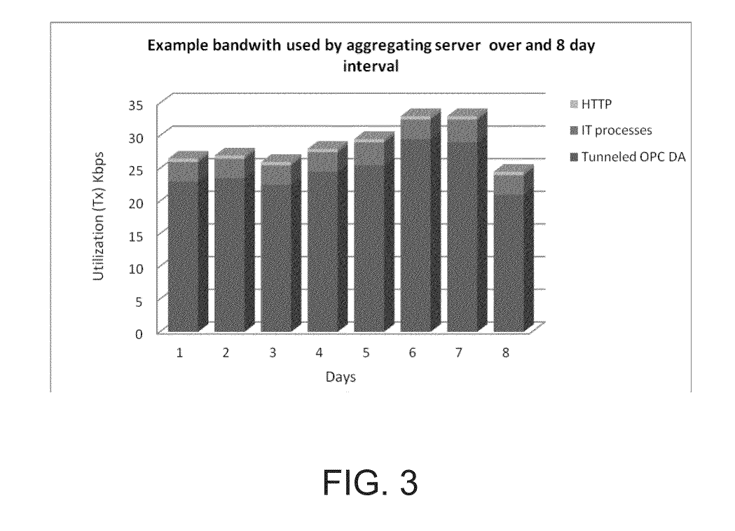

Also shown in FIG. 2 are additional features that may be realized by leveraging the information being gathered with information aggregation systems. For example, information may be provided “on-demand” or streamed in real-time. Additionally, data may be streamed to be scalable to accommodate bandwidth. As an example, FIG. 3 is an illustration of an average bandwidth utilization (transmitting to shore) for an aggregating server on a drilling vessel according to one embodiment of the disclosure. It is a sample breakdown of the average traffic that was generated on a specific installation. The majority of the data is related to tunneled and compressed OPC-DA and OPC-HDA data being transmitted from offshore to the onshore enterprise historian.

In another embodiment, real-time and historical data may be visually presented to personnel on the vessel and to personnel at remote locations, as indicated by the visualization section in FIG. 2. In yet another embodiment, enhanced analytics may performed on the data to add value to the data. As an example, analytics may be applied to the historical data as well as the alarm and events data.

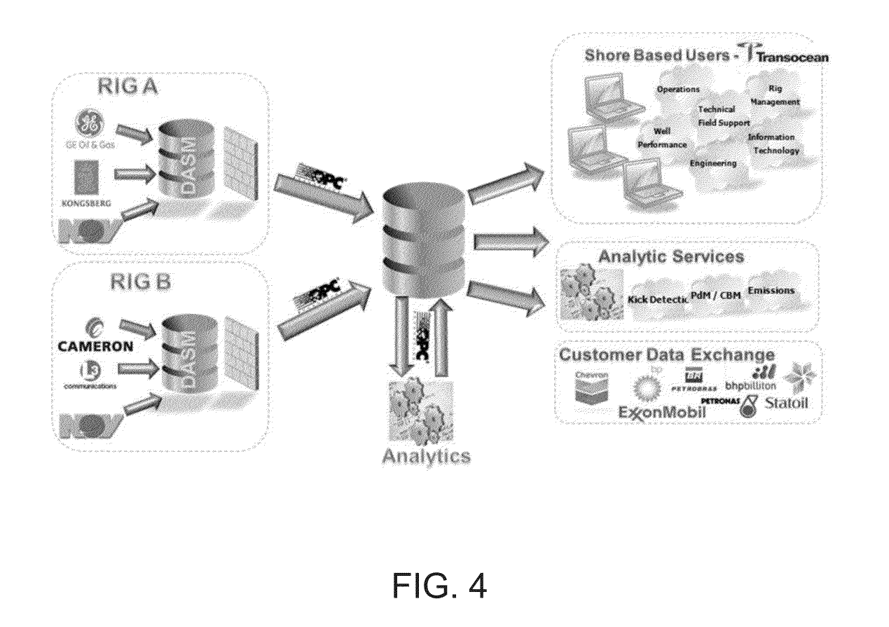

FIG. 4 is an illustration of an aggregation framework of a system for aggregating information on a mobile offshore drilling vessel according to one embodiment of the disclosure. In one embodiment, the framework disclosed in FIG. 4 may leverage existing Ethernet networks of the control systems. FIG. 4 also illustrates the logical connections and data transport mechanisms from a main control system, such as one that is located onshore, to a local information aggregation system on a vessel, as well as illustrating the local logical connections and data transport mechanisms on a vessel.

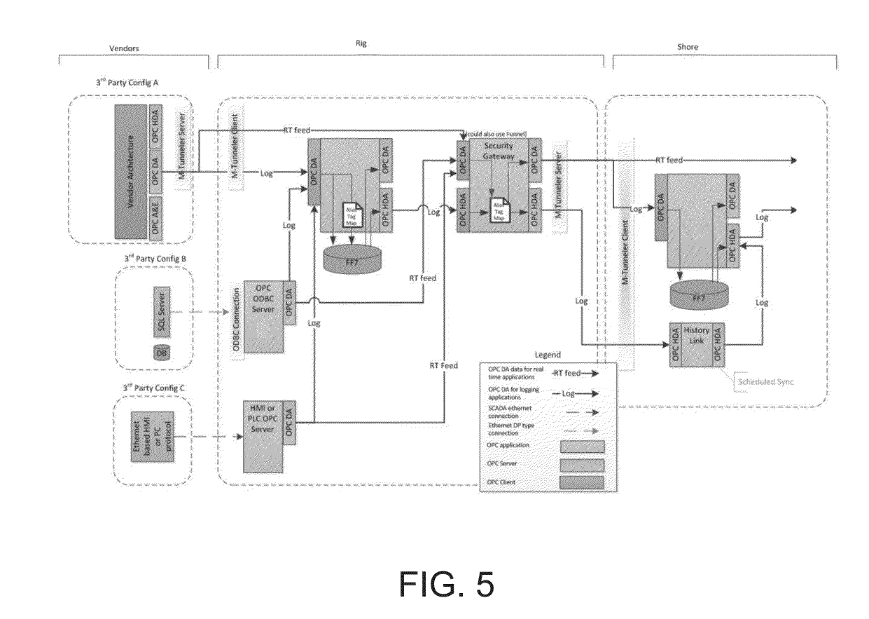

FIG. 5 is an illustration of an example of an OPC DA and HDA synchronization architecture with tunneling and aliasing according to one embodiment of the disclosure. OPC may be an “open” standard that can be used to capture real-time data from the control systems. In the example OPC architecture embodiment disclosed in FIG. 5, there may be two separate interfaces of the OPC standards utilized: OPC DA and OPC HAD.

OPC Data Access (DA) may be used to receive streaming data coming from the control systems. Each data channel, also called a “tag,” may have quality and time information associated with an updated value. In addition, metadata, such as descriptions, units, and customizable entries, may be associated with a specific tag.

OPC Historical Data Access (HAD) may be a distributed component object model (DCOM) interface that provides the ability to query data sets from the past. In one embodiment, data storage may be in the background from which the query may retrieve data. In certain embodiments, historians may be able to provide the interface and an OPC-HDA server. OPC-compliant client tools may then leverage the interface. For example, if a user would like to plot a trend of what some equipment was doing the past hour, the trending tool may use its OPC-HDA client and connect to the historian's OPC-HDA server interface. The OPC-HDA interface may also be used in a distributed architecture offshore to retrieve lost data. For example, if the shore-based historian just used OPC DA, it may have a gap in its logged data due to a period of satellite communications outage, in which the data may not be recoverable. However, if the shore-based historian is also leveraging OPC-HDA, it may have a local system on a vessel recover the missed data by querying past data sets.

In some embodiments, the tag lists for systems may be normalized both in name and engineering units to leverage the logged data onshore from multiple vessels across various control systems with a common set of tools. For example, a vendor's control system tag name may be mapped to a generic form. In addition, the data from a vendor may be converted to a standard set of units, such as SI.

Other OPC protocols may also be used. For example, an OPC A&E, which may be an OPC for alarms and events, may be used. Alarms may be derived from triggers that activate when measured values exceed a defined limit, and the triggers may be unexpected and discrete. In some embodiments, events may be expected. Data from an OPC A&E may be leveraged by a DA-HDA historian. OPC A&E may be handled by the data storage that captures alarms and events management data. Another protocol may be OPC unified architecture (UA), which may encompass functionality provided by DA, HDA, and A&E.

Other advantageous features of this disclosure are now presented. In one embodiment, secure connectivity may be established from a corporate intranet to leverage, at a remote onshore location, information captured from a control system or to provide remote support from shore-based personnel. The secure connectivity may tradeoff performance between confidentiality and system availability. By leveraging pre-existing corporate authentication and authorization connectivity security, as well as networking policies, granular access control to the servers located on vessels may be achieved.

According to one embodiment, this disclosure may also allow for alarm management and aggregation. In terms of data collection, alarm management may follow an almost identical topology to that of data aggregation. In some embodiments, alarm and event collection may differ not only in format, but also in the mechanism for collection. According to one embodiment, within a control system, alarms and events may be captured and/or logged with an OPC A&E, a file, a printer, or may be captured and/or logged by being dumped to an ODBC compliant data base.

Alarm management and aggregation systems may support the aforementioned aggregation tools to access the sources. As with data aggregation, alarms and events may be normalized/standardized into a common format. In some embodiments, a structured query language (SQL) database may serve as a storage mechanism for alarm management and aggregation. Alarm management and aggregation may also utilize a configurable parsing tool or method to identify and differentiate between what may be considered an alarm and what may be considered an event.

Another advantageous feature of this disclosure may be the ability to remotely view designated screens to provide remote support, troubleshooting, and collaboration. The remote connection may require authentication before allowing the remote connection to be established. In some embodiments, there may be two remote sessions that may be established for any remote desktop type connection to a control system. The first may be a remote session from onshore to a proxy server, and the second may be a remote session from the proxy server to the target control system.

Other features of this disclosure may be directed to configuration management and monitoring, such as for management of change, upset recovery, and version management. For management of change, some embodiments may include an automated and auditable software package that may provide a check and balance to establish a particular company's directive in regards to change management. The software packages may automate the audit process programmatically, which may cost effective when increasing control system software audit frequency. The tools may also have automated notification via e-mail and summarize the current state control system software on a vessel.

For upset recovery in the event that a PC or microcontroller fails, even if the spare parts to replace the component are on hand, the logic/code/application may be available to load back onto the device in some embodiments. Therefore, an archive of the entire mission-critical control software may be stored and made available at a consolidated location.

For version management, embodiments of this disclosure may include information aggregation systems that have “check-in”/“check-out” capabilities, as well as the ability to lock a tree node and roll back to previous working configurations.

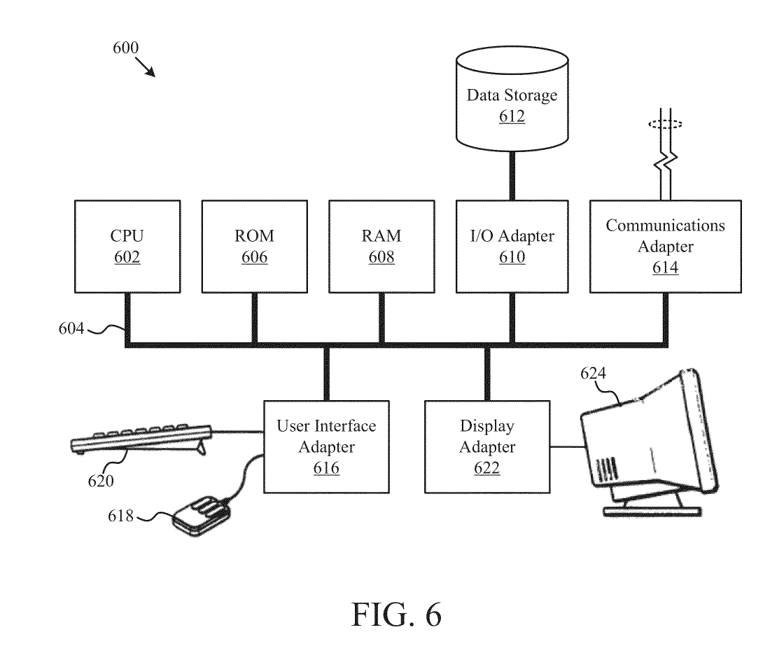

FIG. 6 illustrates a computer system 600 adapted according to certain embodiments as a server and/or a user interface device. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the modules and operations as described herein. The CPU 602 may execute the various logical instructions according to the present embodiments, such as the method illustrated in FIG. 1.

The computer system 600 also may include random access memory (RAM) 608, which may be synchronous RAM (SRAM), dynamic RAM (DRAM), and/or synchronous dynamic RAM (SDRAM). The computer system 600 may utilize RAM 608 to store the various data structures used by a software application, such as information received from the first and second sensors. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a flash drive, a compact disc (CD) drive, a floppy disk drive, and a tape drive, to the computer system 600. The communications adapter 614 may be adapted to couple the computer system 600 to a network, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. The display adapter 622 may be driven by the CPU 602 to control the display on the display device 624.

The applications of the present disclosure are not limited to the architecture of computer system 600. Rather the computer system 600 is provided as an example of one type of computing device that may be adapted to perform the functions of a server and/or a user interface device. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
retrieving data from a plurality of control systems on an offshore drilling vessel, wherein each of the plurality of control systems controls a different feature of the vessel;
aggregating the data at a single location on the vessel;
converting the data into a standard format; and
transmitting the converted data to one or more shore-based locations.

2. The method of claim 1, whereby centralized support, management, and monitoring is provided from the one or more shore-based locations, wherein the centralized support, management, and monitoring effectuates control of at least one of the plurality of control systems on the vessel via communication with the single location on the vessel.

3. The method of claim 1, wherein the method further comprises storing the data at the single location.

4. The method of claim 3, further comprising querying the stored data through a OPC Historical Data Access (HAD) protocol.

5. The method of claim 1, wherein the retrieved data comprises alarm management information.

6. The method of claim 1, wherein the step of retrieving data comprises retrieving data formatted according to OPC Data Access (DA).

7. The method of claim 1, wherein the data is real-time data.

8. An apparatus, comprising:
at least one control system on an offshore drilling vessel; and
a server in communication with each of the at least one control system, wherein the server is configured to:
retrieve real-time data from the at least one control system;
aggregate the data;
convert the data into a standard format; and
transmit the converted data to one or more shore-based locations.

9. The apparatus of claim 8, whereby centralized support, management, and monitoring is provided from the one or more shore-based locations, wherein the centralized support, management, and monitoring effectuates control of at least one of a plurality of control systems on the vessel via communication with the server.

10. The apparatus of claim 8, wherein the server is further configured to store the data.

11. The apparatus of claim 10, wherein the server is further configured to process a query on the stored data through a OPC Historical Data Access (HAD) protocol.

12. The apparatus of claim 8, wherein the retrieved data comprises alarm management information.

13. The apparatus of claim 8, wherein the data is real-time data.

14. The apparatus of claim 8, wherein the server is further configured to retrieve data formatted according to OPC Data Access (DA).

15. A computer program product, comprising:
a non-tangible computer readable medium comprising code to perform the steps comprising:
retrieving real-time data from a plurality of control systems on an offshore drilling vessel;
aggregating the data;
converting the data into a standard format; and
transmitting the converted data to one or more shore-based locations.

16. The computer program product of claim 15, whereby centralized support, management, and monitoring is provided from the one or more shore-based locations, wherein the centralized support, management, and monitoring effectuates control of at least one of the plurality of control systems on the vessel.

17. The computer program product of claim 15, further comprising code to perform the step of storing the data.

18. The computer program product of claim 15, wherein the retrieved data comprises alarm management information.

19. The computer program product of claim 15, wherein the data is real-time data.

20. The computer program product of claim 15, further comprising code to retrieve data formatted according to OPC Data Access (DA).
